(19) United States
(12) Patent Application Publication
(10) Pub. No.: US 2020/0059140 A1
(43) Pub. Date: Feb. 20, 2020

(54) PRODUCTION METHOD AND DISASSEMBLY METHOD FOR A ROTARY PERMANENTLY EXCITED ELECTRICAL MACHINE

(71) Applicant: Siemens Aktiengesellschaft, 80333 München (DE)

(72) Inventor: JOCHEN BRAUN, Passau (DE)

(73) Assignee: Siemens Aktiengesellschaft, 80333 München (DE)

(21) Appl. No.: 16/482,155

(22) PCT Filed: Nov. 20, 2017
(86) PCT No.: PCT/EP2017/079746

§ 371 Date: Jul. 30, 2019

(30) Foreign Application Priority Data
Jan. 31, 2017 (EP) 17153953.9

(51) Int. Cl. H02K 15/03; H02K 15/00

(52) U.S. Cl. CPC H02K 15/03; H02K 15/0006

(57) ABSTRACT

In a method for the production of a rotary permanently excited electrical machine, a magnet body of magnetizable but not yet magnetized material is secured in or on a rotor body of a rotor such that the magnet body is arranged in a region of pole yet to be formed. An electrical conductor is arranged around the pole yet to be formed and the rotor body is fastened on a rotor shaft. The rotor shaft, including the rotor body with the magnet body and the electrical conductor, is mounted in a subsequent operating position relative to a stator. A pulse current is applied to the electrical conductor after mounting of the rotor shaft to thereby form the pole of the rotor as the magnet body is magnetized, and ends of the electrical conductor are electrically connected to one another after formation of the pole of the rotor.

The present invention proceeds from a production method for a rotary permanently excited electrical machine,
wherein a stator of the electrical machine is produced,
wherein a rotor body of a rotor of the electrical machine is produced,
wherein magnet bodies which are composed of magnetizable, but not yet magnetized, material are positioned and fixed in the or on the rotor body, so that the magnet bodies are arranged in the region of poles of the rotor which are yet to be formed,
wherein electrical conductors are arranged around the poles of the rotor which are yet to be formed,
wherein the rotor body is fastened on a rotor shaft,
wherein the rotor shaft, including the rotor body with the not yet magnetized magnet bodies and the electrical conductors, is mounted in its subsequent operating position relative to the stator,
wherein, after the rotor shaft is mounted in its subsequent operating position relative to the stator, a pulse current is applied to the electrical conductors and the poles of the rotor are formed in this way owing to magnetization of the magnet bodies.

The present invention is further based on a disassembly method for a rotary permanently excited electrical machine,
wherein the electrical machine has a rotor comprising a rotor body and has a stator,
wherein magnet bodies which are composed of magnetized material are positioned and fixed in the or on the rotor body, so that the magnet bodies are arranged in the region of the poles of the rotor,
wherein electrical conductors are arranged around the poles of the rotor,
wherein the rotor body is fastened on a rotor shaft,
wherein a pulse current is first applied to the electrical conductors and the magnet bodies are demagnetized in this way,
wherein the rotor shaft, including the rotor body with the now no longer magnetized magnet bodies and the electrical conductors, is only then moved out of its operating position relative to the stator.

In permanently excited electrical machines, the electromagnetic force is created by the interaction of the magnetic fields which are generated, on the one hand, by a stator winding which is arranged in the stator of the electrical machine and, on the other hand, by permanent magnets which are arranged on or in the rotor body of the rotor of the electrical machine.

Permanent magnets exert large forces on ferromagnetic materials, such as the laminations of the rotor body or of the stator. Therefore, the exact positioning of the magnets on or in the rotor body is difficult. Special apparatuses which can exert the forces necessary for this purpose are often required. Without apparatuses of this kind, the rotor bodies of large permanently excited electrical machines often cannot be populated for safety reasons.

Following population of the rotor body, further assembly of the electrical machine, in particular the insertion of the rotor body, which is populated with the magnet bodies, into the stator of the electrical machine in the case of a conventional internal rotor for example, is also difficult. Expensive and complicated apparatuses are also often once again required for this purpose in order to be able to cope with the forces which occur in this case. In particular, during assembly, contact between the permanent magnets and the laminated core of the stator has to be reliably prevented. Otherwise, the rotor would adhere to the stator on account of the high magnetic forces and it would be possible to disconnect the stator again only with difficulty.

It has already been proposed to introduce the rotor into the stator (that is to say to introduce the rotor into the stator in the axial direction) while the rotor body is not yet populated with the magnet bodies. In this case, the magnet bodies are introduced into the rotor body by means of corresponding insertion apparatuses at a later time. This procedure is laborious and costly. Furthermore, it can be realized only in the case of so-called buried permanent magnets, that is to say when the magnet bodies are inserted into pockets of the rotor body. However, this procedure cannot be realized when the magnet bodies are arranged on the outside on the lateral surface of the rotor body.

The same problems are encountered in respect of disassembly of the rotor of a permanently excited electrical machine. In particular, the rotor can be withdrawn from the stator in the axial direction only by means of a special apparatus which can overcome the high magnetic attraction forces. As an alternative, it is possible to heat the entire electrical machine to a temperature above the Curie temperature of the magnet bodies for a sufficiently long period of time, to demagnetize the magnets in this way and to remove the rotor from the stator after the demagnetization of the magnet bodies.

A production method and a disassembly method of the kind mentioned at the outset are known from U.S. Pat. No. 9,508,479 B1 for example. Similar contents of disclosure can be found in DE 100 49 766 A1 and DE 10 2007 025 971 A1.

A first object of the present invention is to provide a possible way for the electrical machine to be able to be produced and in particular assembled in a simple manner and for the poles of the rotor to be reliably protected during operation.

The first object is achieved by a production method having the features of claim 1. Advantageous refinements of the production method are the subject matter of dependent claims 2 and 3.

According to the invention, a production method of the kind mentioned at the outset is configured in that the ends of the conductor or of the conductors are electrically connected to one another after the poles of the rotor are formed. As a result, it is possible for the conductors to provide a protective function for the magnet bodies during normal operation of the electrical machine.

It is possible for a dedicated conductor to be arranged around each pole which is to be formed. As an alternative, it is possible for a continuous conductor to be arranged around the poles which are to be formed.

A second object of the present invention is to provide a possible way for an electrical machine of this kind to be able to be disassembled in a simple manner and for the poles of the rotor to be reliably protected during operation.

The second object is achieved by a disassembly method having the features of claim 4.

According to the invention, a disassembly method of the kind mentioned at the outset is configured in that the ends of the conductor or of the conductors are electrically connected to one another and are electrically separated from one another before the pulse current is applied.

The above-described properties, features and advantages of this invention and the manner in which they are achieved become clearer and more easily understandable in connection with the following description of the exemplary embodiments which are explained in greater detail in connection with the drawings, in which schematically:

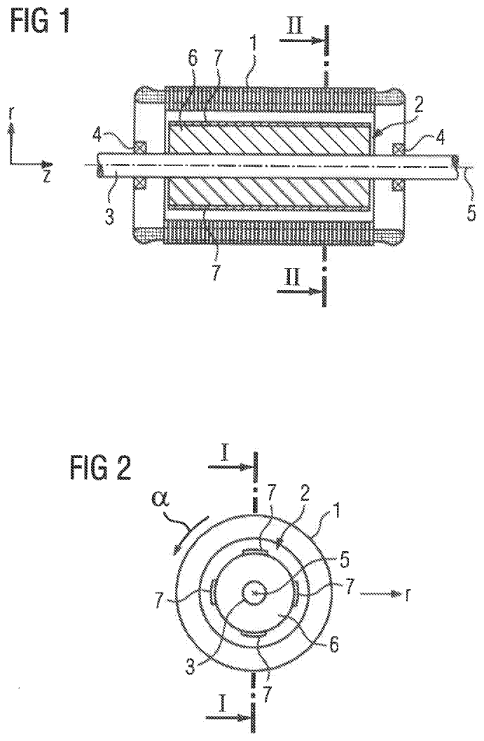

FIG. 1 shows a longitudinal section through an electrical machine along a line I-I in FIG. 2,

FIG. 2 shows a cross section through the electrical machine from FIG. 1 along a line II-II in FIG. 1, and

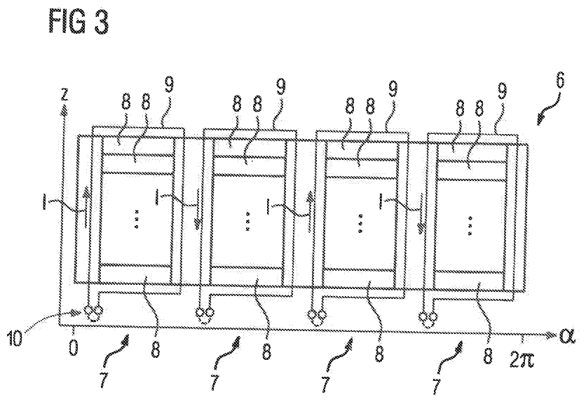

FIG. 3 shows the casing of a rotor body illustrated in unrolled form.

According to FIGS. 1 and 2, an electrical machine has a stator 1 and a rotor 2. The rotor 2 is arranged on a rotor shaft 3 in a rotationally fixed manner. The rotor shaft 3 is mounted in bearings 4 in its operating position. The bearings 4 are stationary with respect to the stator 1. For example, the bearings 4 can be arranged in so-called end plates which, for their part, are fastened to a housing which surrounds the stator 1. On account of the rotor shaft 3 being mounted in the bearings 4, the rotor shaft 3 and, with it, the rotor 2 can be rotated about an axis of rotation 5 of the electrical machine. Therefore, the electrical machine is a rotary electrical machine.

Where the terms “axial”, “radial” and “tangential” are used in the text which follows, they always relate to the axis of rotation 5. “Axial” is a direction parallel to the axis of rotation 5. “Radial” is a direction orthogonal to the axis of rotation 5 toward the axis of rotation 5 or away from the axis of rotation 5. “Tangential” is a direction which is both orthogonal to the axial direction and orthogonal to the radial direction. That is to say, “tangential” is a direction which is directed in the form of a circle around the axis of rotation 5 with a constant axial position and at a constant radial distance from the axis of rotation 5. Furthermore, the axial direction is provided with the reference symbol z, the radial direction is provided with the reference symbol r and the tangential direction—that is to say the mechanical angle—is provided with the reference symbol α in the text which follows.

According to FIGS. 1 and 2, the rotor 2 comprises a rotor body 6. The rotor body 6 comprises, in particular, a laminated core. The rotor body 6 is that part which is connected to the rotor shaft 3 in a rotationally fixed manner. The rotor 2 further comprises a number of poles 7. The poles 7 are arranged on the rotor body 6. The number of poles 7 can be as required. An exemplary embodiment in which the number of poles 7 is four will be described in the text which follows. However, the number of poles 7 could be smaller or larger. The poles 7 are formed by permanent magnets in line with the illustration in FIG. 2. Therefore, the electrical machine is a permanently excited electrical machine.

In order to produce the electrical machine, the stator 1 of the electrical machine is firstly produced. This process is generally known to persons skilled in the art and can be performed in an entirely conventional manner within the scope of the present invention too. Therefore, this process will not be explained in any detail in the text which follows. The stator 1 can be produced at any time. It merely has to be completed when the rotor shaft 3 is later mounted into the bearings 4. However, the particulars of production of the rotor 2 in connection with joining of the stator 1 and the rotor 2 are as according to the invention.

In order to produce the rotor 2, the rotor body 6 is first produced. The rotor body 6 forms the so-called active part of the rotor 2, that is to say the stack of electrical sheets including the associated fastening elements by means of which the stack of electrical sheets are compressed and held together. The rotor body 6 can also be produced in an entirely conventional manner. Therefore, this is not explained in any detail in the text which follows. However, it is critical within the scope of the present invention that the rotor body 6 does not include the poles 7.

After the rotor body 6 is produced, magnet bodies 8 are positioned and fixed on the rotor body 6. FIG. 3 shows this state. The magnet bodies 8 can be positioned and fixed in a conventional manner as such. In particular, positioning and fixing are performed in such a way that the magnet bodies 8 are arranged in the region of the poles 7 of the rotor 2. However, it is critical within the scope of the present invention that the magnet bodies 8 are composed of magnetizable material, but the material is not yet magnetized. Therefore, no magnetic forces act on or in the rotor body 7 at the time at which the magnet bodies 8 are positioned and fixed. In particular, the magnet bodies 8 can therefore be positioned on the rotor body 6 in a considerably more simple manner than if the magnet bodies 8 were already magnetized. In particular, it is possible to position the magnet bodies 8 in a highly accurate manner because the magnet bodies 8 do not exert any magnetic forces on one another or the rotor body 6. The magnet bodies 8 can be fixed as required, for example by adhesive bonding or by potting. It is also possible to apply a bandage.

The magnet bodies 8 are arranged in the region of the poles 7 of the rotor 2 by way of the positioning and fixing processes. However, on account of the condition that the magnet bodies 8 are not yet magnetized, the poles 7 are not yet formed.

In the illustration of FIG. 3, the magnet bodies 8 are arranged on the rotor body 6. Basically the same procedures are also possible when the magnet bodies 8 are not arranged on the rotor body 6 but rather in the rotor body 6, that is to say on the lateral surface of the rotor body 6 are covered by material of the rotor body 6.

In a subsequent step, electrical conductors 9 are arranged around the poles 7 of the rotor 2 which are yet to be formed, in line with the illustration in FIG. 3. The electrical conductors 9 are likewise fixed. The electrical conductors 9 surround the poles 7 generally at least in a U shape as seen in an axial-tangential plane. As an alternative, the electrical conductors 9 can surround the poles 7 with a complete turn or several complete turns too. As seen in the radial direction r, the conductors 9 can be arranged at the same level as the magnet bodies 8, above the magnet bodies 8 or below the magnet bodies 8. In line with the illustration in FIG. 3, it is possible for a dedicated electrical conductor 9 to be placed around each pole 7. In this case, there are in each case two conductor ends 10 for each pole 7. As an alternative, it is possible for only one single continuous conductor 9 to be placed around the poles 7. In this case, there are only two conductor ends 10 in total. Intermediate stages, that is to say one conductor 9 is placed around several but not around all poles 7, are also possible.

In a further step, the rotor body 6 is fastened on the rotor shaft 3 in a rotationally fixed manner. Said rotor body is fastened on the rotor shaft 3 in a conventional manner and will therefore not be explained in any detail in the text which follows. As an alternative, this can be done before or after the magnet bodies 8 are positioned and fixed on the rotor body 6.

After the rotor body 6 with the magnet bodies 8 arranged on the rotor body 6 is fastened on the rotor shaft 3 in a rotationally fixed manner, the rotor shaft 3, including the rotor body 6 with the magnet bodies 8 and the electrical conductors 9, is mounted relative to the stator 1 in its subsequent operating position. The electrical machine is therefore basically in the state shown in FIGS. 1 and 2. However, the magnet bodies 8 are still not yet magnetized at this point in time. Therefore—just like during subsequent operation in which the rotor 2 and the stator 1 interact in an electromagnetic manner—the rotor 2 can be rotated about the axis of rotation 5 in this state. However, on account of the condition that the magnet bodies 8 are not yet magnetized and accordingly the poles 7 are not yet formed, no electromagnetic forces act between the stator 1 and the rotor 2. This is also the case when current is applied to a stator winding which is arranged in the stator 1.

The poles 7 of the rotor 2 are formed only now, that is to say after the rotor shaft 3 is mounted relative to the stator 1 in its operating position and therefore substantially after complete mechanical assembly of the electrical machine. To this end, a pulse current I is applied to the electrical conductors 9—individually in succession or simultaneously depending on the configuration. The pulse current I creates a high magnetic field in the region which is enclosed by the conductor 9 or the conductors 9—that is to say substantially in the region of the poles 7 which are to be formed—for a short time. The pulse current I is determined in such a way that the magnetic field which is generated by the pulse current I in the region of the poles 7 exceeds the coercive field strength of the magnet bodies 8. Therefore, the pulse current I causes the magnetization of the magnet bodies 8 and correspondingly the formation of the poles 7 of the rotor 2.

It is possible to electrically connect the ends 10 of the conductor 9 or of the conductors 9 to one another after the poles 7 of the rotor 2 are formed. This is schematically indicated in FIG. 3 by corresponding dashed lines.

In order to disassemble a rotary permanently excited electrical machine which is produced in such a way, the reverse procedure can be followed. In particular, a pulse current I is first applied to the electrical conductors 9 in this case and the magnet bodies 8 are demagnetized in this way. If required, the ends 10 of the conductor 9 or of the conductors 9 are electrically separated from one another before the pulse current I is applied. The rotor shaft 3, including the rotor body 7 with the now no longer magnetized magnet bodies 8 and the electrical conductors 9, is only then, that is to say when the rotor bodies 8 are demagnetized, moved out of its operating position relative to the stator 1.

Therefore, in summary, the present invention relates to the following substantive matter:

In order to produce a rotary permanently excited electrical machine, a stator 1 and a rotor body 6 of a rotor 2 of the electrical machine are produced. Magnet bodies 8 which are composed of magnetizable, but not yet magnetized, material are positioned and fixed in the or on the rotor body 6, so that the magnet bodies 8 are arranged in the region of poles 7 of the rotor 2 which are yet to be formed. Electrical conductors 9 are arranged around the poles 7 of the rotor 2 which are yet to be formed. The rotor body 6 is fastened on a rotor shaft 3. The rotor shaft 3, including the rotor body 6 with the as yet unmagnetized magnet bodies 8 and the electrical conductors 9, is mounted in its subsequent operating position relative to the stator 1. After the rotor shaft 3 is mounted relative to the stator 1, a pulse current is applied to the electrical conductors 9 and the poles 7 of the rotor 2 are formed in this way owing to magnetization of the magnet bodies 8. The ends 10 of the conductor 9 or of the conductors $ are electrically connected to one another after the poles 7 of the rotor 2 are formed. The reverse procedure is followed for the purpose of disassembling the electrical machine.

The present invention has a large number of advantages. In particular, it is possible to produce and to assemble and also to once again disassemble the electrical machine in a simple manner, without magnetic forces occurring during the assembly and the disassembly of the electrical machine.

Although the invention has been illustrated and described in detail by the preferred exemplary embodiment, the invention is not restricted by the disclosed examples and other variations can be derived therefrom by a person skilled hi the art without departing from the scope of protection of the invention.

1.-4. (canceled)

5. A method for the production of a rotary permanently excited electrical machine, said method comprising:
securing a magnet body of magnetizable but not yet magnetized material in or on a rotor body of a rotor such that the magnet body is arranged in a region of pole yet to be formed;
arranging an electrical conductor around the pole yet to be formed;
fastening the rotor body on a rotor shaft;
mounting the rotor shaft, including the rotor body with the magnet body and the electrical conductor, relative to a stator in its subsequent operating position;
applying a pulse current to the electrical conductor after mounting of the rotor shaft relative to the stator in the subsequent operating position to thereby form the pole of the rotor as the magnet body is magnetized; and
electrically connecting ends of the electrical conductor to one another after formation of the pole of the rotor.

6. The method of claim 5, wherein a plurality of said magnetic body are arranged in regions of a plurality of said pole yet to be formed, with a plurality of said electrical conductor being arranged around the poles yet to be formed such that each of the poles is surrounded by a dedicated one of the electrical conductors.

7. The method of claim 5, wherein a plurality of said magnetic body are arranged in regions of a plurality of said pole yet to be formed, with the electrical conductor being a continuous conductor arranged around the poles.

8. A method for the disassembly of a rotary permanently excited electrical machine having a stator and a rotor with a rotor body that is fastened on a rotor shaft, said method comprising:
electrically separating ends of an electrical conductor which is arranged around a pole of the rotor;
applying a pulse current to the electrical conductor after separation of the ends of the electrical conductor to thereby demagnetize a magnet body that is arranged in or on the rotor body in a region of the pole; and
removing the rotor shaft including the rotor body with the demagnetized magnet body and the electrical conductor relative to the stator from its operating position.
